(19) United States
(12) Patent Application Publication
(10) Pub. No.: US 2002/0107927 A1
(43) Pub. Date: Aug. 8, 2002

(54) Apparatus and method for increasing safety using the internet

(76) Inventor: Stephen I. Gallant, Cambridge, MA (US)

Correspondence Address: PERKINS, SMITH & COHEN LLP, ONE BEACON STREET, 30TH FLOOR, BOSTON, MA, 02108, US

(21) Appl. No.: 10/028,901

(22) Filed: Dec. 20, 2001

Related U.S. Application Data
(63) Continuation-in-part of application No. 09/516,058, filed on Mar. 1, 2000.
(60) Provisional application No. 60/139,645, filed on Jun. 17, 1999.

(51) Int. Cl. G06F 15/16; G08B 23/00

(52) U.S. Cl. 709/206; 340/573.1

(57) ABSTRACT

A safety system reduces personal risk by establishing a Web-based method of verifying that an individual returns from a date, a hike, or vacation when expected and, if not, of automatically alerting friends and relatives and summoning help from the police. The safety system also enables elderly or infirm individuals to routinely indicate their well-being on a regular basis, e.g. daily, an alert being sent in the absence of a signal. Further, the safety system provides a Web-based repository for personal information and a mechanism of controlled access to this information by other parties.

### CROSS-REFERENCE TO RELATED APPLICATIONS

This application is a continuation-in-part of U.S. patent application Ser. No. 09/516,058 entitled, “Apparatus and Method for Increasing Personal Safety Using the Internet,” filed Mar. 1, 2000 that claims priority of U.S. provisional application Serial No. 60/139,645 entitled, “Apparatus and Method for Increasing Personal Safety Using the Internet” filed Jun. 17, 1999 by the present applicant.

### FIELD OF THE INVENTION

This invention relates generally to devices and methods of network communications and more particularly to those facilitating personal safety across a network including a wireless telephone network.

### BACKGROUND OF THE INVENTION

The ascendance of the Internet and the World Wide Web (the “Web”) has made it easier for an individual to establish social contact with other individuals, but at increased personal risk.

Increasingly people are meeting through the Internet, or by other means that limit the ability for a person to verify the identities and characters of the other individuals involved. This increases the risk that a person will find himself or herself in a dangerous situation during, for example, a first date. To make matters worse, the widespread fear of such situations inhibits social interactions, and thereby makes it more difficult to pursue the social interactions desired by many people.

To reduce risk and fear associated with such activities, it is advised that an individual inform a friend of each date and each potentially dangerous activity, such as a solitary mountain hike. A friend, however, may not always be available, or it may be inconvenient or embarrassing to reveal extensive details of the planned activity which need only be divulged in case of an emergency.

Business activities can involve similar perceived risks. For example, a pizza delivery person may be apprehensive about a delivery to a perceived dangerous area of a city. The deliverer could, in theory, call the office just before the delivery to express concerns, and just after the delivery to verify safe return, but this action is seldom practical for either the deliverer or the company.

In addition, there are circumstances in which a person wants or needs to provide verified personal information. Documents, in some instances, will suffice for the information and its verification, however, in some cases, documents are inconvenient or inadequate. A readily available data repository of personal information is often necessary.

It remains desirable to have a way of increasing the safety of activities arising from person-to-person contact over the Internet.

It is an object of the present invention to provide an automated, remote personal alert method and apparatus.

It is another object of the present invention to provide a method and apparatus to maintain verified personal information for release to requesting parties.

It is another object of the present invention to provide a method and apparatus for a first person to send a secret alarm message while under a threat from another person in close physical proximity to the first person.

### SUMMARY OF THE INVENTION

The problems of providing a personal alert are solved by the present invention of a web-based safety system.

In one embodiment of the invention, the invention reduces personal risk by establishing a convenient Web-based method of verifying that an individual returns from a date, hike, delivery or vacation when expected and, if not, of automatically alerting friends and relatives and summoning help from police. Similarly, this embodiment of the invention establishes a way for elderly or infirm individuals to routinely indicate their continued well-being, for example on a daily basis, so that family is automatically alerted in the absence of a signal. If the individual also carries a wireless telephone such as a cell phone or a satellite telephone, the present invention can also trigger the telephone location system if the individual does not signal on or before a preprogrammed time. The location of the wireless telephone (and presumably also the location of the individual) is determined and the information is forwarded as instructed, to a friend perhaps or directly to police.

Further, a convenient Web-based repository for personal information and a mechanism of controlled access to this information by other parties is established. This procedure will add confidence in personal interactions and business interactions, including applications for jobs, credit, and insurance.

Additionally, when elderly or infirm people are living alone, there is a utility in being able to affirm, at regular intervals, their continued well-being so that help will be summoned automatically if no affirmation of well-being is received.

Similarly, there is a need for easier and more flexible release and verification of individual identity and contact information, both for social and for business relationships, such as applications for jobs, credit, and insurance.

Finally, a method for entering a secret help message at a computer terminal so that any other person watching the computer monitor is not aware that the help message is being sent is described.

The present invention together with the above and other advantages may best be understood from the following detailed description of the embodiments of the invention illustrated in the drawings, wherein:

### BRIEF DESCRIPTION OF THE DRAWINGS

FIG. 1 is a block diagram of the Internet safety system according to principles of the invention;

FIG. 2 is a block diagram of the user record of FIG. 1;

FIG. 3 is a flow chart of Internet safety system of FIG. 1; and, FIG. 4 is a flow chart of the personal information release system using the system of FIG. 1.

### DETAILED DESCRIPTION OF PREFERRED EMBODIMENTS

The term “personal information” as used in the following description and claims shall refer to data that identifies a person and shall include at least the name of the person and may additionally include the address and telephone number of the person, the person's doctor, special medical conditions, e-mail address, etc.

The term “Internet” includes electronic mail (also known as “e-mail”), World Wide Web protocols, and similar systems of communication over large networks. “Connection to the Internet” includes dedicated lines, normal phone lines, wireless communication, automated telephone systems that interface with a computer system, and other modalities that provide an interface to the Internet. The telephone network includes all forms of telecommunication including land lines, cellular telephones and satellite telephones.

One embodiment of the invention is an Internet-based process that increases safety with personal interactions (such as blind dates with someone met through the Internet) and potentially dangerous solo activities (such as solitary mountain hikes). A second embodiment has an Internet registry in which personal information is verified, with the extent of the release of the personal information controlled by the individual. Finally, this invention gives a method for entering a secret help message at a computer terminal so that any other person watching the computer monitor is not aware that the help message is being sent. This could be especially useful in a kidnap situation, or just to quickly summon help from pre-specified relatives and agencies while supplying them with extensive pre-specified information about location, physical conditions, and easy entry to the dwelling.

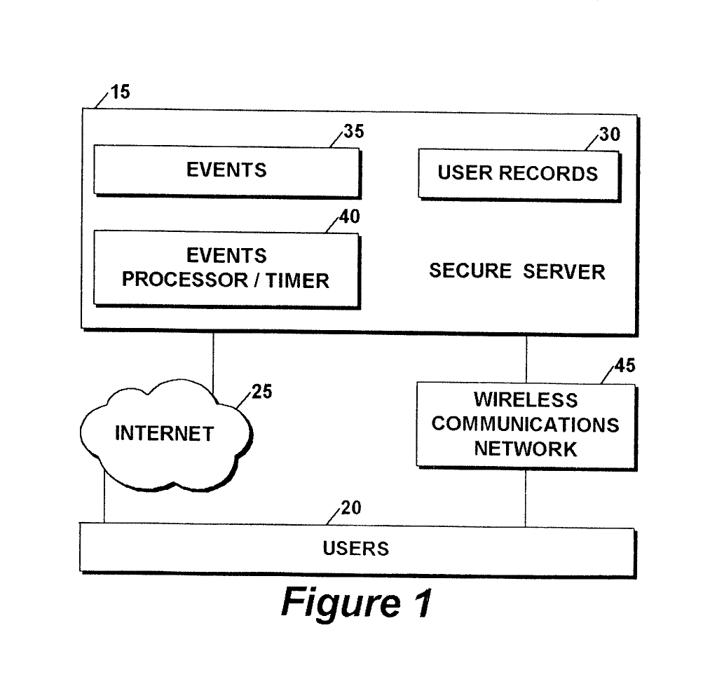

FIG. 1 shows the safety system according to principles of the present invention. The system has a secure server 15 available to users 20 over the Internet 25. The secure server is also available to users 20 over a wireless communications network 45. The secure server 15 has a database of user records 30, an event database 35, and an events processor and timer 40. A user registers with the secure server 15 and provides information to be stored in the user records database 30. When an event arises that the user wants monitored, the user provides the event information including the end date and time. The events database 35 stores a flag for the event, and the events processor 40 monitors the event flag. If the user does not check in with the secure server 15 by the provided end date and time, the events processor/timer 40 follows the instructions provided by the user in his or her user record. Instructions could include sending a reminder to the user that the event flag has not been canceled, generating a data message to a friend or family member, or signaling a call center to notify a police authority directly by telephone. The instructions could further include using the user's wireless telephone or other wireless device having a locator signal to determine where the individual is. Among the potential uses for this information is sending the location to a friend or relative or alternatively sending the information to the police.

Events may optionally be staged to occur at different intervals. This may be accomplished by setting a plurality of flags having different expiration times. Different instructions may be associated with each expiration time. For example, the first expiration time may trigger a reminder message to the user that event flags have been set and the alarm time is approaching. The second expiration time may trigger the alarm. Other stages may be set according to the needs of the user.

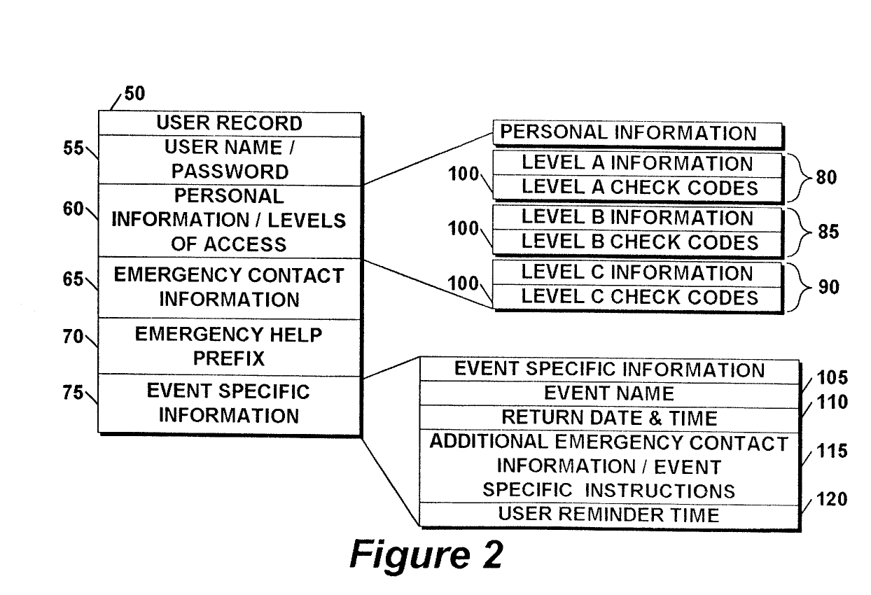

FIG. 2 shows the user record 50 maintained in the user records database 30. The user record 50 includes the user name and password to the secure server 55, personal information 60 provided by the user, emergency contact information 65, an emergency help prefix 70 specified by the user, and event specific information 75. The personal information 60 is divided into levels, each level containing a quantum of personal information to allow the user to release different amounts of personal information as the user specifies. Three levels, level A 80, level B 85 and level C 90 are shown in FIG. 2, however, more or fewer levels can be established within the scope of the invention. Each level is password-protected with one or more check codes 100. The user provides a check code to another, the check code enabling access to the user's personal information at the particular check code level. The emergency contact information 65 is provided by the user and has the names and contact information to be used in the event that the user does not cancel an event flag. The emergency prefix 70 is a trigger that enables the user to set off an immediate silent alert and to type information into the web site without having it appear on the user interface. It is useful for raising an alarm and for providing help information without bringing it to the attention of someone reading over the user's shoulder. The event specific information 75 has an event name 105 or other designation given to the event by the user. The user also provides one or more dates and times for event actuation 110, i.e., times by which the events flag should have been canceled by the user. The user may also provide event specific instructions 115 that may override the general emergency contact information. The user may also provide a user reminder time 120 before the return date and time. Alternatively, the user make include a reminder instruction in the event specific instructions.

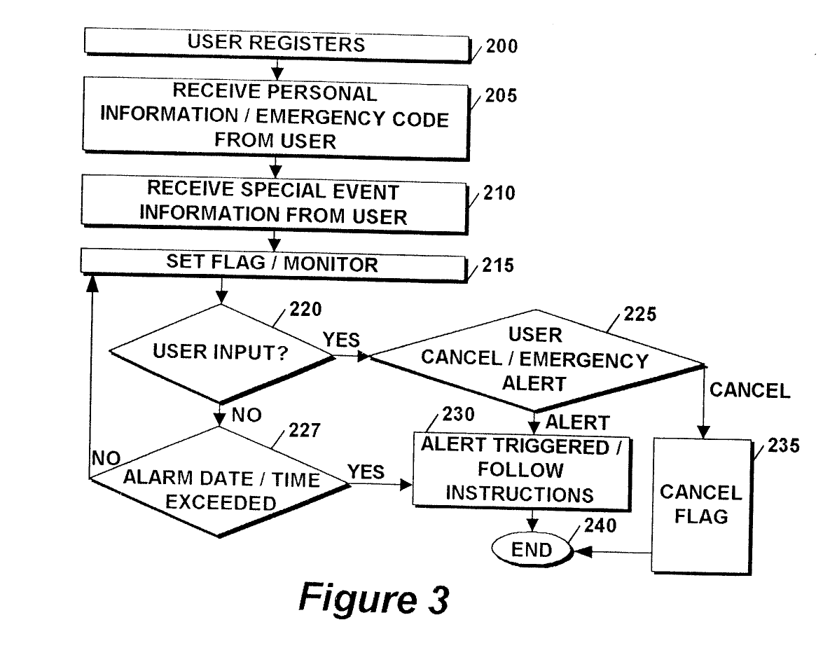

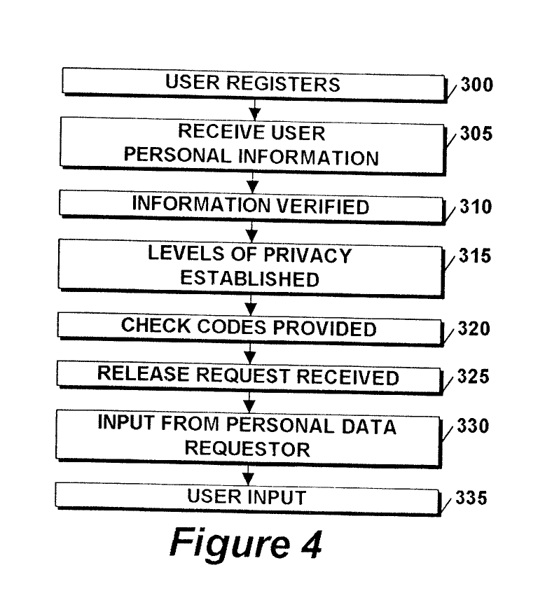

FIG. 3 is a flow chart of the preferred method of the safety system which provides a way to automatically check that someone has safely returned from a date, outing, or similar event using the Internet or Web. First, the customer signs up for the service over the Web, block 200. The user provides general personal and emergency contact information, block 205, to avoid having to reenter this information in the future. All interactions with the server are secure and password protected. In addition, the customer establishes an “emergency help prefix,” for example “hh”. Next, before an event, the customer enters event information, block 210, including a return date and time, alternatively a trigger date and time, and any additional contact or emergency information particular to this event, as described above with regard to FIG. 2. The return date and time should be late enough to allow for any normal delays. The secure server sets a flag in the events flag database, and proceeds to monitor, block 215. If the user does not cancel the flag before the specified date and time, the events processor will find the flag still set in the flags database and the events processor will follow the instructions provided in the user record. The system can receive user input before an alert is triggered, block 220. If there is a user input, it is one of two types, block 225. The first type is a cancellation of an event flag because the user has returned safely from the outing. The second type is an emergency alert. If things run as expected, the user returns safely in a timely fashion and cancels the events flag, block 235, before the specified date and time (requiring the Web access password for that customer) and the process ends. Alternatively, it is possible for the user to enter an alert signal instead. For example, if in personal danger such as a kidnap situation, the user may signal for help by entering any character string beginning with the emergency help prefix rather than specifying the normal password. For example, the customer might type “hhbob13elm” rather than the normal password, and the screen would show “**********” as is normal for passwords. In this case, the Web page returned to the customer would be exactly the same as if the customer had completed a normal login operation, but in fact an emergency response would be immediately triggered, with the additional information “bob13elm”. A suffix or similar code known to those skilled in the art of computer science would work equally well for this purpose.

If the user does not cancel the event flag and the period before an alert has been exceeded, block 227, an alert is triggered and the instructions left by the user are followed, block 230. The instructions could include contacting a friend of the user or contacting the police. A plurality of contact modalities could be used in the present invention, including e-mail messaging, pager alerts, automated telephone notifications, and personal telephone notifications. The instructions could further include using a locator device on the user's wireless telephone, and forwarding that information to the appropriate parties. The system continues to monitor, block 215, as long as the alert time has not been exceeded, unless the user intervenes with a cancellation or an emergency alert.

Additionally, in the preferred implementation, the customer would be able to specify a “reminder time”. At this time, email would be sent to the customer, reminding the customer of the need to act on the safety system. Alternately, the user could receive an automated alert on his or her wireless device reminding him or her of the upcoming deadline. Such a warning would also be a way to demonstrate to another party, in a dangerous situation, that the other party could not escape detection of any impending crime.

Additionally, with particular advantage for elderly or infirm people living alone, an events flag could automatically be activated on a regular basis, for example daily. A dedicated electronic device or computer, connected to the Internet, could permit the elderly person to signal continued well-being every day by pressing one or more buttons. Conversely, if no such signal is received then relatives and medical personnel should be alerted automatically.

Similarly, the user may enter a sequence of reminder times. This could be useful for a trucking company to verify that certain stages of a trip were completed on time, and to be automatically alerted if this was not the case.

Finally, in the preferred embodiment, there would be an additional phone contact number in case the customer could not access the Internet. All communication would be logged, and would require a call back from the telephone center to some listed number.

FIG. 4 is a flow chart of the personal information release system. The personal information release system is a means for increasing safety in personal and business relationships by making available part or all of the personal information obtained from a client.

In the preferred embodiment, a user first registers with the personal information release system, block 300. The user provides personal information such as name, address, phone number, birth date, employment, marital status, HIV status, and previous addresses, block 305. The user also provides verification of the data, for example photocopies of relevant documents, such as drivers license, phone bill, payroll stub, or utilities bill.

Next, optionally, some or all of this information might be independently verified, block 310. For example, the client's phone might be called, employer contacted, or home visited.

The user designates one or more levels of information to be released under various options, block 315. For example, Level A may be to release the fact that various information is on record, for example employer, without releasing specifics, for example, the name of the employer. Level B might be to release option A information plus phone and address. And Level C might be to release all information. In the preferred embodiment, the client would also agree that this information may be divulged to law enforcement officials in the course of a request that is reasonably believed to be valid.

In the next step, the client receives one or more “check codes” to authorize the release of information at a particular level to another party, block 320. This code might be, for example, a string of 10 digits and letters, like a password. The client may also specify the number of releases that may be obtained with this code, for example, one release only.

The client may now give this “check code” to a person or a business that desires additional confidence in the identity or trustworthiness of the client. In the preferred embodiment, the client may also authorize distribution of this information to other parties, provided those parties pay the client a specified fee. When the system receives a request to release information and a valid check code, the system releases the information at the appropriate level to the requesting party, block 325.

Additionally, in the preferred embodiment, the client must agree that one who receives a check code may make comments to be entered into the clients record, block 330, along with a response by the client, block 335, and that this information would be released to others at some or all release levels.

Additionally, the person who receives a “check code” may, in the first part of this invention, record said “check code” as part of the safety system information to be automatically divulged in case the person fails to cancel the event flag in a timely fashion, or in case that person enters an “emergency help prefix”.

It is to be understood that the above-described embodiments are simply illustrative of the principles of the invention. Various and other modifications and changes may be made by those skilled in the art which will embody the principles of the invention and fall within the spirit and scope thereof.

What is claimed is:

1. A method of notifying a second party, comprising the steps of:
a) setting a timer by a first party to expire at an end time in a computer;
b) if the first party fails to stop the timer prior to the expiration of the end time,
i) activating a locator device in a wireless device carried by the first party to determine the location of the first party; and
ii) sending a message including the first party's location to the second party.

2. The method of claim 1 wherein said second party is a call center.

3. The method of claim 1 wherein said second party is a police authority.

4. The method of claim 1 wherein said wireless device is a wireless telephone.

5. The method of claim 1 further comprising the step of sending an alarm deactivation reminder message to said first party on said wireless device.

6. A personal security system, comprising:
a computer network;
a wireless communication network having a capability of locating wireless communication devices connected to said wireless communications network;
a secure server connected to both said computer network and said wireless communication network, said secure server having a database for storing at least one alarm time and associated instructions, said secure server also having at least one timer, said secure server to obtain the location of a wireless communication device from said wireless communications network and forward the location according to instructions stored in said database if said timer is not shut off before said at least one stored alarm time.

7. The personal security system of claim 6, wherein said wireless communications network is a wireless telephone network and said wireless communication device is a wireless telephone.

8. The personal security system of claim 6, wherein said secure server further comprises means for sending an alarm deactivation reminder message to said wireless communications network to be forwarded to said wireless device.

9. The personal security system of claim 6, further comprising a connection to a police authority to carry a location message in response to said stored instructions.
